(19) United States
(12) Patent Application Publication
(10) Pub. No.: US 2013/0196154 A1
(43) Pub. Date: Aug. 1, 2013

(54) METHOD FOR PRODUCING PELLETS FROM FIBER COMPOSITE MATERIALS AND CARBON FIBER CONTAINING PELLET

(71) Applicants: GERALD ORTLEPP, UHLSTAEDT-KIRCHHASEL (DE); RENATE LÜTZKENDORF, KOENIGSEE (DE); THOMAS REUSSMANN, RUDOLSTADT (DE)

(72) Inventors: GERALD ORTLEPP, UHLSTAEDT-KIRCHHASEL (DE); RENATE LÜTZKENDORF, KOENIGSEE (DE); THOMAS REUSSMANN, RUDOLSTADT (DE)

(73) Assignee: SGL AUTOMOTIVE CARBON FIBERS GMBH & CO. KG, MUENCHEN (DE)

(21) Appl. No.: 13/588,130

(22) Filed: Aug. 17, 2012

Related U.S. Application Data
(63) Continuation of application No. PCT/EP2011/000485, filed on Feb. 3, 2011.

(30) Foreign Application Priority Data
Feb. 17, 2010 (DE) 10 2010 008 349.6

(51) Int. Cl. C08K 7/06; B29B 9/04

(52) U.S. Cl. CPC C08K 7/06; B29B 9/04
USPC 428/357; 264/118

(57) ABSTRACT

A method produces pellets from fiber composite materials suitable for further processing in a plastics finishing method. The pellets contain individual carbon fibers, carbon fiber bundles, or a mixture thereof and at least one thermoplastic matrix material. The carbon fibers, carbon fiber bundles, or a mixture thereof are isolated from waste or used parts that contain carbon fiber, laid flat together with the thermoplastic matrix material, compressed into a sheet material under the effect of heat, and subsequently cooled and comminuted into pellets, platelets, or chips. This enables the use of carbon fibers, from production waste components, as reinforcing fibers, whereby an inexpensive raw material is provided and the carbon fibers that are contained in the waste materials are recycled. The final carbon fibers are brought into a pourable and readily meterable form and can be used as raw materials for extrusion or injection molding for example.

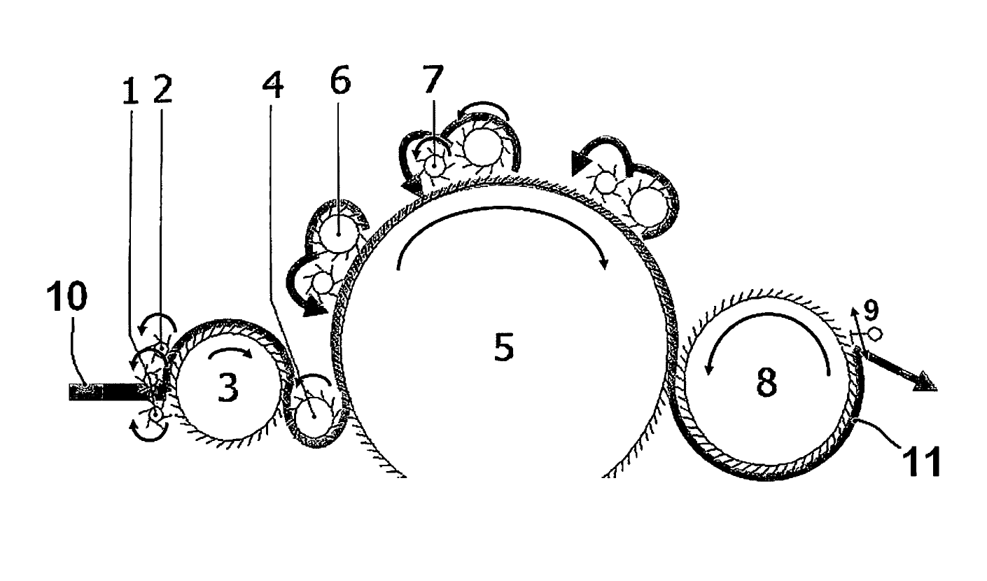

### CROSS-REFERENCE TO RELATED APPLICATION

This application is a continuation, under 35 U.S.C. §120, of copending international application No. PCT/EP2011/000485, filed Feb. 3, 2011, which designated the United States; this application also claims the priority, under 35 U.S.C. §119, of German patent application No. DE 10 2010 008 349.6, filed Feb. 17, 2010; the prior applications are herewith incorporated by reference in their entirety.

### BACKGROUND OF THE INVENTION

### Field of the Invention

The present invention relates to a method for producing pellets of fiber composite materials suitable for further processing in a plastics finishing method, wherein the pellets contain carbon fibers and at least one thermoplastic matrix material.

Carbon fibers are used as the fiber reinforcement of fiber composite materials (FCM) bonded with thermoplastics or duromers. In order to achieve maximized reinforcing effects, until now this has been carried out mainly by using continuous carbon fiber materials such as filament yarns, multifilament yarns or rowings. In contrast, carbon fibers are not offered on the market in the form of cut fibers with discontinuous fiber lengths, for example with a length in the range 20 mm to 80 mm, as is known in conventional textile processing, because they are more problematic to process.

For a number of years now, the use of carbon fiber materials as high performance fiber reinforcement has been increasing. The main applications are, for example, in aircraft construction, ship construction, vehicle construction and in wind power facilities. Because of the ever-increasing volumes used, the quantity of carbon fiber-containing production waste is also increasing, as well as the amount of worn out used parts. Because they are complicated to manufacture, carbon fibers are very expensive. Prices can be between approximately 15 [symbol] /kg to approximately 300 [symbol] /kg for special types. For economic and environmental reasons, it would thus be desirable to create opportunities for processing the waste and used parts and the carbon fibers they contain and to provide new applications in which they can at least partially replace expensive primary carbon fibers.

Although attempts have already been made in the industry to recycle carbon fiber-containing production waste, in which the waste is cut and/or ground and, for example, used as reinforcement in plastics or building materials, until now only a small fraction of this waste has actually been collected and marketed. Until now, there has been no high added value recycling of large quantities of carbon fiber-containing waste, and so it has had to be disposed of as trash.

If fiber composite materials are used in an extrusion or injection molding technique, the raw materials have to be dosed in a constant ratio by weight of fibers to thermoplastic polymer. Good dosing and mixing can only be accomplished when the two entities of the mixture are the same or at least very similar as regards their geometrical dimensions, particle surface area and bulk factor. However, short fibers and ground dust exhibit very large differences in these parameters compared with the grains of plastic granulate which are used, which as a rule have a diameter of approximately 3 mm to 5 mm, a smooth surface and thus good pourability. The individual fibers in a short fiber fill latch together in a randomly orientated mat, form fiber bridges and clumps of material, which can block the openings in the infeed hoppers of extruders and injection molding machines, resulting in uncontrolled, sporadic entry into the machine. In addition to the resulting interruptions in a continuous stream of material for the machine feed, substantial deviations from the nominal mixing ratio of reinforcing fibers to plastic matrix may occur in the end product, which means that the mechanical properties of the component cannot be guaranteed.

For the above reasons, until now, raw materials for extrusion or injection molding which contain primary carbon fibers are produced from continuous fiber strands. To make them readily processable, the continuous fibers are formed into bundles and prior to cutting into lengths of 3 mm to 12 mm, they are bonded into a thick continuous fiber bundle using a very sticky binding ply also known as sizing. Continuous fibers can also be bundled together and then encased or impregnated with a molten polymer, cooled to solidify it and then cut to the desired length. In this process, only continuous primary carbon fibers can be used as the raw material. For the reasons given above, discontinuous fibers, which result from waste processing procedures or from recycling used CFK components, cannot be added directly to the raw materials for extrusion or injection molding as the fibers. Only when it becomes possible to use these in a form that can be properly dosed and which pours well will the way be open to recycling carbon fibers from waste or used parts, which are still high value fibers, in an economic manner.

In the prior art, the manufacture of primary carbon fibers is usually carried out by starting from either suitable organic precursor fibers such as polyacrylonitrile (PAN) or from viscose fibers and carrying out controlled pyrolysis, or by starting from pitch, in which case melt spinning is used to produce an initial pitch fiber which is then oxidized and carbonized. An appropriate process is known from published, European patent application EP 1 696 057 A1, corresponding to U.S. Pat. No. 7,634,840, for example. In that document, primary fibers produced from pitch are processed into staple fiber mats in which the fibers have an orientation in a preferred direction. The known process contains, inter alia, a carding process to make the fibers parallel. However, this process produces a yarn from a carbon fiber web, and thus a linear end product is produced.

Primarily, it is known in the art that a tape-like consolidated semi-finished product can be produced from a hybrid strip containing reinforcing fibers of discontinuous length and thermoplastic matrix fibers. Published, non-prosecuted German patent application DE 101 51 761 A1 describes a process of this type, in which initially a carded tape is produced from thermoplastic matrix fibers and natural fibers, which then pass through a store, a guide and finally a laying unit. After heating in a heating zone and consolidation, a tape-like semi-finished product is obtained. That document also mentions that instead of natural fibers, carbon fibers may be used as reinforcing fibers.

Published, non-prosecuted German patent application DE 10 2008 002 846 A1, corresponding to U.S. patent publication No. 2011/0057341, describes a waste processing method in which fiber-reinforced or fiber-containing semi-finished products are recycled. The fibers bonded into a matrix material are separated from the matrix material and the free fibers obtained are immediately cured with a binder. However, separation of the fibers from the semi-finished product is carried out in a furnace, i.e. by pyrolysis. In this method, the end product is a bundle of fibers formed by cured fibers; the document does not provide any details regarding further processing thereof.

Published, non-prosecuted German patent application DE 197 39 486 A1, corresponding to U.S. Pat. No. 5,879,802, discloses a method for the manufacture of a sheet-like semi-finished product formed from fiber composite material, in which a recycled thermoplastic material, namely fiber waste from carpet manufacture, is mixed with a waste material from headline manufacture and carded with a carding machine. The thermoplastic fibers may consist of polypropylene, polyethylene, nylon or PET. These fibers are shredded into approximately 50 mm long strips before further processing. The waste material from the headline manufacture is plucked apart by rolls with needle-like projections and divided into strips. Both waste fiber materials are mixed and then carded with a card machine. The document contains no further information regarding taking any measures to specifically orientate the fibers. Further, that document does not teach the use of carbon fibers from waste. In that known method, a mat is initially produced which is then molded into a body component for a vehicle.

Published, non-prosecuted German patent application DE 197 11 247 A1 describes a method for the manufacture of long fiber granulates from hybrid sliver. In this method, hybrid sliver formed from reinforcing fibers and matrix fibers are heated, compacted by twisting and formed into a strand. In this case, a linear continuous product is produced by melting the thermoplastic fiber components and cooling. The twist on the material strand is retained and then that string is cut to length into pellets by cutting it across using a granulator.

Published, non-prosecuted German patent application DE 44 19 579 A1, corresponding to U.S. Pat. No. 5,595,696, describes a method for the manufacture of pellets formed from fiber composite material in which a plastic granulate is fed to an extruder, which melts it, and then cut glass fibers with a uniform length are added downstream. The mass is then extruded from a slot die, segmented and divided into pellets. The quantity of fiber in the pellets that are produced is comparatively low. No carbon fibers are used in the known method, and no recycled fibers are processed.

Japanese patent abstract 2005089515 A describes a method for the manufacture of pellets from fiber composite materials in which carbon fibers and a thermoplastic matrix material containing a phenolic resin and a styrene resin are processed with a proportion of rubber to pellets in which the carbon fibers are oriented in the longitudinal direction of the pellets. The carbon fiber content is 5-30% by weight. Carbon fibers are used therein which are manufactured using a conventional process primarily for pellet production; thus, they constitute a comparatively expensive raw material. In addition, continuous fibers are used as the starting material and for this reason, the length of the carbon fibers is the respective length of the pellets.

### SUMMARY OF THE INVENTION

The aim of the present invention is to provide a method for the manufacture of pellets formed from fiber composite materials of the aforementioned type, wherein inexpensive, available carbon fibers can be used as the reinforcing fibers.

In accordance with the invention, carbon fibers are isolated from carbon fiber-containing waste or used parts, they are laid flat together with a thermoplastic matrix material and compressed into a sheet material using heat, then cooled and comminuted into pellets, batts or chips.

The method of the invention means that discontinuous carbon fibers, carbon fiber bundles or a mixture thereof, for example formed from textile production waste, bonded or cured production waste, processed used CFK components or the like can be used as reinforcing fibers, whereby an inexpensive raw material is provided and the carbon fibers contained in the used materials can be recycled for further use. The discontinuous carbon fibers, carbon fiber bundles or a mixture thereof are thus put into a compact form that can be poured and properly dosed and can, for example, be used as raw materials for extrusion or injection moulding.

Concerning carbon waste or used parts which are impregnated with bonding resins or CFK components or part components, in which the carbon fibers are embedded in a solid composite, the carbon fibers are initially freed from the unwanted matrix substances. To this end, pyrolysis techniques may be used, for example, or the waste may be treated using supercritical solvents. Discontinuous carbon fibers are the product from these separation processes.

Preferably, at least one ply of discontinuous carbon fibers, carbon fiber bundles or a mixture thereof is produced by laying it flat in a pneumatic random laying process, a carding process, a wet lay process, a paper production process or as a loose fill.

In a further embodiment of the invention, unlike the case of the prior art where a linear fiber sliver is formed, the carbon fibers are processed in a fleece forming unit directly into a thin, mass-homogeneous fibrous web and thus forms flat, mass-homogeneous carbon fiber-containing plies of adjustable thickness and mass per unit area.

The carbon fibers, carbon fiber bundles or a mixture thereof used in accordance with the invention exhibit, as a function of the web formation process, a mean fiber length of 3 mm to 150 mm. Short fibers of up to 10 mm can be processed using the wet lay process; longer fibers in the range 20 to 150 mm can be processed using the random laying technique or carding into sheet goods.

In the context of the present invention, there are various preferred possibilities for mixing the carbon fibers with the thermoplastic matrix material. As an example, at the inlet to a carding unit, carbon fibers and thermoplastic fibers can be fed in in the form of a fiber flock mixture or as separate plies and then homogeneously mixed in the carder.

When using the wet lay method, short carbon fibers can be intimately pre-mixed with thermoplastic particles, for example short fibers, in the suspension fluid of the wet lay unit.

As an example, it is also possible to bring at least one mass-homogeneous thermoplastic ply consisting of at least one thermoplastic foil, fiber web ply or fleece ply, possibly in the form of a melt, into contact with at least one mass-homogeneous flat ply of discontinuous carbon fibers, carbon fiber bundles or a mixture thereof formed in an upstream fleece-forming process by lamination.

Alternatively, a thermoplastic component in the form of a powder or as particles with a diameter of less than approximately 5 mm can be applied to at least one ply of discontinuous carbon fibers, carbon fiber bundles or a mixture thereof in such a ply.

As an example, a thermoplastic component in the form of discontinuous fibers can be intimately and homogeneously mixed with the carbon fibers before or during ply formation.

The result of the above examples is a flat intermediate product in which discontinuous carbon fibers, carbon fiber bundles or a mixture thereof are loosely associated with at least one thermoplastic component in a defined, constant weight ratio. In accordance with the present invention, at least one thermoplastic component is then softened or fused by a heating process and the carbon fibers are preferably consolidated by flat compression and cooling to a bend-resistant ply or sheet such that after the subsequent comminution process, the result is pellets that can be poured and are suitable for injection molding and compounding. In contrast to published, non-prosecuted German patent application DE 44 19 579 A1, for example, which operates with melt impregnation and extrusion, the adjustable fiber content in the resulting pellets can be adjusted to 95%, substantially over the limit of 35% cited in DE 44 19 579 A1, and thus inexpensive carbon fiber concentrates can be produced in pellet form for compounding.

Temperature and pressure during thermal consolidation, in combination with the percentage and type of polymer of the fusing, bonding or softening thermoplastic material determines the mechanical cohesiveness of all of the components in the pellet and thus the applicability to injection molding or compounding.

The present invention also pertains to a carbon fiber-containing pellet which is produced using a method of the type cited above and which preferably has a proportion of carbon fibers in the range 5% to 95%, preferably in the range 10% to 80%, and wherein the maximum edge-to-edge length of the pellet is 3 to 25 mm, preferably 5 to 10 mm. Preferably, the carbon fibers, carbon fiber bundles or a mixture thereof in the pellet does not have a uniform fiber length and parts thereof do not pass through the whole pellet body without interruption.

In addition to carbon fibers, carbon fiber bundles or a mixture thereof formed from carbon fiber-containing waste or used parts, a pellet of the invention may, for example, contain a fraction of carbon fibers, carbon fiber bundles or a mixture thereof in the form of discontinuous primary goods (new goods). In addition to carbon fibers, this pellet may also, for example, contain further reinforcing fiber fractions in discontinuous form, in particular para-aramid, glass fibers, natural fibers, infusible chemical fibers and/or fibers that melt at a higher melting point than the matrix fibers.

Techniques that are specific for the production of mass-homogeneous or volume-homogeneous carbon fiber-containing mats that may be used depend on the type of discontinuous carbon fibers, carbon fiber bundles or a mixture thereof used primarily depend on the fiber lengths and fiber length distribution. Examples are known dry techniques such as fleece carding, pneumatic fleece laying, the formation of a loose fill using dispersing devices when using shorter fibers of up to approximately 10 mm or by means of a feed chute for a medium fiber length of >10 mm, as well as wet techniques such as wet lay manufacture or paper technologies. It is also possible to use powder dispersion for extremely short fibers up to approximately 5 mm as the process step producing a ply.

Examples of raw carbon fiber materials for the method are as follows:
comminuted primary fibers and/or comminuted rovings;
comminuted and/or disaggregated laid, woven or braided remnants;
comminuted and/or disaggregated filament waste or leftover spooled material;
comminuted and/or disaggregated and/or heat- or solvent-treated prepreg waste; or
discontinuous carbon fibers and/or discontinuous carbon fiber bundles, if necessary further comminuted and/or disaggregated resin-containing waste, cured CFK parts and/or used parts.

Depending on the carbon fiber length present, they can be fed directly into the ply formation process or, in order to improve processability, they can be further comminuted and/or, for example, be provided with or mixed with a size, binding substances or other additional agents that are effective in the subsequent plastic, such as flame retardants, dyes, unmolding aids or rheological aids. It is also possible to mix additional functional fibers in with the carbon fiber materials, for example to modify the impact strength or to provide mechanical reinforcement, such as para-aramid, glass fibers, natural fibers or infusible chemical fibers or fibers that melt at a higher temperature. Fibrous admixers such as thermoplastic fibrous material for subsequent bonding may be mixed intimately and homogeneously with the remaining fibers in a stand-alone process step prior to ply formation, for example using a textile fiber mixing belt or directly during ply formation, for example in a carder. If system mixing is employed, the individual fiber components are laid unmixed over each other, for example in different plies, as a fibrous web or fleece tape. What is important here is that after thermoplastic curing, the thermoplastic binding components penetrate sufficiently through all plies in order to ensure compact binding of all of the plies together. This can be accomplished by homogeneously mixing all of the components together, for example by alternating thin plies with the thermoplastic and reinforcing components or, for example, by intensive needling of thermoplastic binder fibers through the carbon fiber ply using a needling procedure. With thin plies or good penetrability with a thermoplastic melt, a sandwich is suitable, wherein the non-fusible components are arranged as a core.

A variety of thermoplastic plastic matrixes that are known in the art may be used as the thermoplastic binding components. These range from low melting point polyethylene via polypropylene, polyamides, up to high melting point thermoplastics such as PEEK or PEI. The thermal consolidation parameters such as temperature, residence time, pressure and any use of an inert gas atmosphere have to be matched to the peculiarities of that polymer. The form of the thermoplastic binder component that may be used ranges from small particles such as powders via short fibers, textile staple, fleece or fibrous plies, spin laid materials and foils to polymer melts.

Depending on the combination of the discontinuous carbon fibers with the thermoplastic binder in flat plies with as constant a weight ratio of carbon fibers to thermoplastic as possible, this laminate is heated so that the thermoplastic component softens or melts. When using a polymer melt, however, this step would not be necessary. In this case, it may, for example, be applied to the carbon fiber ply by use of wide dies—then compressed and then cooled and consolidated with or without applying additional external mechanical pressure.

The fraction of thermoplastic components determines the compactability of the sheet goods and the mechanical stability of the subsequent pellets which can be obtained. The lower limit for the thermoplastic fraction is preferably approximately 5%, whereby for a reliable consolidation effect, the carbon fibers and thermoplastic components should be mixed as homogeneously and intimately as possible. For sandwich processes, minimum fractions of approximately 15% to 25% are advantageous in order to obtain good cohesiveness in the subsequent pellet. If the resulting pellets are to be used in compounding, then for economic reasons, a high carbon fiber content and as low a binder polymer content as possible is preferably employed. If the pellets are to be injection molded directly into components, the thermoplastic polymer is preferably used in fractions of >50%, in general 70% to 90%.

The fraction of thermoplastic components can, for example, be used to vary the hardness of the pellets within a wide range. This extends from a compact pore-free condition via increasing porosity to a heat-consolidated low density fiber fleece. In addition to the carbon fiber materials used, further fibrous materials in discontinuous form may be used. In analogous manner to the carbon fiber components, these may be added by fiber mixing processes before or during ply formation, or as a separate system component when laminating the material.

The heat-consolidated sheet goods are then comminuted in a defined manner. This may, for example, be carried out using a die-cutting process, using comb cutting technology or a combination of 2 gravity cutting machines. The particle size depends on the parameters of the compounder or injection molding machine; preferably, a maximum dimension of 15 mm is generally not exceeded. Pellets which are easy to process may, for example, have maximum edge lengths of 5 to 10 mm. The pellets do not have to have a regular or uniform shape. The thickness of the pellets is of minor importance. Regarding good cohesion, very thick, weighty pellets must have a higher minimum thermoplastic fraction than thin platelet-shaped pellets which, because of their smaller mass, can tolerate smaller inertial forces on dosing and admixing without being destroyed.

The range of applications of such carbon pellets preferably encompasses compounding and injection molding for the production of thermoplastically bonded fiber composite materials. Examples of other fields of application with particularly low melting point binder fractions are elastomer or rubber-reinforcements or an application as pellets with a low degree of consolidation in duromer matrixes which, for example disaggregate again in the duromer during the mixing processes to release the carbon fibers so that they can be properly distributed in the duromer matrix.

The features defined in the dependent claims preferably concern further embodiments of the subject matter of the invention. Further advantages of the invention will become apparent from the following detailed description.

The present invention will now be explained in more detail with the aid of specific examples. It should be understood that these examples are purely by way of example and the invention is in no way limited to the specific measures and parameters described therein.

### EXAMPLE 1

Processing a fiber/fiber mixture to pellets for injection molding.

In order to manufacture carbon fiber-containing pellets for injection molding, recycled carbon fibers obtained from 100% woven carbon waste with a mean fiber length of 40 mm and a standard 3.3 dtex, 60 mm PA6 staple fiber textile, was used as the raw material. Both materials were intimately mixed together in a weight ratio of 70% PA6 to 30% recycled carbon fibers (RCF) using a mixing bed that is standard to the textile industry and a subsequent opening machine to form a so-called flock mixture. This fiber mixture then went through a carding unit and the flat card web with a homogeneous mass per unit area of 35 g/m² which was produced with a fiber mixture of 70/30 PA6/RCF via a cross-lapper was doubled to form a multi-web laminate with a mass per unit area of 260 g/m² and then consolidated using a needler with 25 stitches/cm² so that on the one hand the fleece was easy to manipulate in the subsequent processes and on the other hand, the stitch intensity was not too high, in order to obtain carbon fibers in the fleece which were as long as possible. 10 such needle fleeces with a mass per unit area of approximately 250-260 g/m² were laid over each other in the form of 30 cm×30 cm pieces and compressed with a multiplate press at 240° C. using 50 bars for 100 s, then cooled. The still unconsolidated soft edges were removed from the resulting sheets using a guillotine. Next, the sheets were comminuted on a Pierret gravity knife machine with a cut of 6.3 mm, initially lengthwise into strips and then the strips were relaid and cut across into chip-like pellets with edge lengths in the range 4 to 10 mm depending on the target cut accuracy. The pellets were irregular in shape; ideally square, but most were irregular elongated rectangles or polygons up to irregular triangles. These shapes result from the comminution technique employed for sheet goods and are not of primary importance for use in injection molding. What is much more important is that there were no oversized pellets which could block the infeed hopper in the downstream units. These pellets so produced could then be processed in an injection molding machine directly to FVW.

### EXAMPLE 2

Processing of a flat system mix to pellets for compounding.

Two fleece webs with a mass per unit area of 180 g/m² were produced from 100% of a standard 3.3 dtex, 60 mm PA6 staple fiber textile on a carder unit using a cross-lapper and a downstream needling machine. The two fleece webs were only lightly needled, once with 12 stitches/cm² from above. In the next step, recycled carbon fibers formed from 100% woven waste with a mean fiber length of 40 mm were processed to a flat carded web with a homogeneous weight per unit area of 30 g/m² using a carding technique which was specially adapted to processing carbon fibers, and the web drawn from the carder was continuously laid with a cross-lapper at an angle of 90° thereto and overlapped so that a mass per unit area of 780 g/m² was laid. Between the laid web and the carbon fiber web ply to be lapped was a pre-prepared needle fleece web so that the carbon fiber ply was disposed on the PA6 needle fleece. Before running into the downstream needle machine, the second 180 g/m² PA6 needle fleece was rolled over as a cover ply so that a 180 g/mol PA6-needle fleece −780 g/m² RCF-web ply −180 g/m² PA6 needle fleece sandwich was produced. This sandwich was firmly needled with 25 stitches/cm² from above and below. The needling procedure meant that parts of the PA6 fleece cover plies were needled through the RCF ply so that a certain amount of quasi-mixing of the PA6 with the RCF ply occurred, which had a positive effect on the stability of the subsequent thermal consolidation. The needle fleeces obtained with a PA6 outer ply and RCF in the core were laid over each other in 30 cm×30 cm pieces and compressed with a multiplate press at 240° C. at 50 bars for 100 seconds and then cooled. The still unconsolidated soft edges were removed from the resulting sheets using a guillotine. Next, the sheets were comminuted on a Pierret gravity knife machine with a cut of 9.8 mm initially lengthwise into strips and then the strips were relaid and cut across into chip-like pellets with edge lengths in the range 7 to 14 mm depending on the target cut accuracy. The pellets were irregular in shape; ideally square, but most were irregular elongated rectangles or polygons up to irregular triangles. These shapes result from the comminution technique employed for sheet goods and are not of primary importance for use in injection molding. What is much more important is that there were no oversized pellets which could block the infeed hopper in the downstream units. These pellets so produced could then be processed in an extruder to carbon fiber-containing injection molding granulates with a fiber fraction of 10% RCF.

Other features which are considered as characteristic for the invention are set forth in the appended claims.

Although the invention is illustrated and described herein as embodied in a method for producing pellets from fiber composite materials and carbon fiber containing pellet, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The FIGURE of the drawing is a simplified illustration showing the principle of a carding unit which is, for example, suitable for the production of a fibrous web containing, inter alia, carbon fibers in accordance with the method of the invention.

### DETAILED DESCRIPTION OF THE INVENTION

Referring now to the single FIGURE of the drawing in detail, there is shown at least one fiber ply 10 entering a carder unit (on the left), which initially passes over infeed rolls 1, 2 onto a licker-in 3 which rotates in the opposite direction to the infeed rolls 1,2. Between the licker-in 3 and a tambour 5 which turns in the same direction as the licker-in 3 is a transfer roller 4 which turns in the opposite direction to the licker-in 3 and the tambour 5. On the circumference of the tambour 5 are various workers 6 and turners 7 at different positions on the circumference. These devices function to disaggregate the incoming fiber ply 10 in the carder unit to individual fibers and then to reform them into a thin, mass-homogeneous fiber web with a defined mass per unit area. Preferably, the fibers become orientated along their length.

Behind the tambour 5 is a take-off drum 8 which rotates in the opposite direction to the tambour 5, which drum 8 has a comb blade 9 located on its downstream side. A fiber web 11 is taken from the take-off drum 8 in the form of an continuous web which, for example, has a maximum mass per unit area of approximately 80 g/m², preferably a maximum of approximately 60 g/m², as well as a fiber length orientation of approximately 15-30 g/m², for example.

1. A method for manufacturing pellets from fiber composite materials suitable for further processing in a plastics finishing method, the pellets containing carbon fibers and at least one thermoplastic matrix material, which comprises the steps of:
isolating carbon fibers, carbon fiber bundles or a mixture thereof from waste or used parts which contain the carbon fibers;
laying flat the carbon fibers with the thermoplastic matrix material resulting in a flat sheet;
compressing the flat sheet into a sheet material using heat;
cooling the sheet material; and
comminutating the sheet material into one of pellets, batts or chips.

2. The method according to claim 1, which further comprises initially producing, at least one ply of discontinuous carbon fibers by flat laying the carbon fibers being discontinuous carbon fibers in one of a pneumatic random laying process, a carding process, a wet lay process, a paper manufacturing process or a loose fill process.

3. The method according to claim 1, wherein the carbon fibers, the carbon fiber bundles or the mixture thereof which are used have a mean length of 3 mm to 150 mm.

4. The method according to claim 2, wherein the at least one ply running into a carding unit is processed directly to a thin, mass-homogeneous fiber web.

5. The method according to claim 4, wherein at an inlet to the carding unit, the discontinuous carbon fibers, the carbon fiber bundles or a mixture thereof and thermoplastic fibers are each fed in as separate plies and then mixed in a carder.

6. The method according to claim 1, which further comprises bringing at least one thermoplastic ply, containing at least one thermoplastic foil, fiber web ply or fleece ply, into contact, with at least one ply of carbon fibers being discontinuous carbon fibers, the carbon fiber bundles or a mixture thereof.

7. The method according to claim 2, which further comprises:
applying a thermoplastic component in a form of a powder or as particles with a diameter of less than approximately 5 mm to the at least one ply of discontinuous carbon fibers, the carbon fiber bundles or a mixture thereof; and
heating the ply.

8. The method according to claim 2, which further comprises mixing a thermoplastic component in a form of discontinuous fibers intimately and homogeneously with the carbon fibers, the carbon fiber bundles or the mixture thereof prior to or during ply formation.

9. The method according to claim 1, wherein individual components, namely the carbon fibers, the carbon fiber bundles or the mixture thereof, thermoplastic matrix fibers and any other fibers with a different composition are each fed unmixed in different plies as fiber webs or fleece webs and laid flat over each other and measures are taken to ensure sufficient penetration of all plies by the thermoplastic matrix components and compact binding of the plies together following a thermal consolidation.

10. The method according to claim 1, wherein for isolating the carbon fibers, the carbon fiber bundles or the mixture thereof formed from the waste or the used parts from unwanted matrix substances, pyrolysis techniques or treatment with supercritical solvents are employed.

11. The method according to claim 6, which further comprises providing the at least one thermoplastic ply in a form of a melt.

12. The method according to claim 2, which further comprises:
impregnating the ply with a thermoplastic component in a form of a powder or as particles with a diameter of less than approximately 5 mm; and
heating the ply.

13. The method according to claim 2, which further comprises bringing a thermoplastic component in a form of a melt is into contact with the at least one ply of discontinuous carbon fibers.

14. A carbon fiber-containing pellet, comprising:
fibers selected from the group consisting of carbon fibers, carbon fiber bundles and a mixture of carbon fibers and carbon fiber bundles;
at least one thermoplastic matrix material, said fibers with said thermoplastic matrix material being laid flat resulting in a flat sheet, said flat sheet being compressed into a sheet material using heat and the sheet material being cooled and comminutating into the carbon fiber-containing pellet; and
a proportion of said fibers being in a range of 5% to 95% and a maximum edge-to-edge length of the carbon fiber-containing pellet is 3 to 25 mm.

15. The carbon fiber-containing pellet according to claim 14, wherein said fibers contained in the pellet do not have a uniform fiber length and parts thereof do not pass through a whole body of the carbon fiber-containing pellet without interruption.

16. The carbon fiber-containing pellet according to claim 14, further comprising a fraction of carbon fibers in a form of discontinuous primary goods.

17. The carbon fiber-containing pellet according to claim 14, further comprising reinforcing fibers in discontinuous form.

18. The carbon fiber-containing pellet according to claim 14, wherein said proportion of said fibers being in a range of 10% to 80% and said maximum edge-to-edge length of the carbon fiber-containing pellet is 5 to 10 mm.

19. The carbon fiber-containing pellet according to claim 17, wherein said reinforcing fibers are selected from the group consisting of para-aramid, glass fibers, natural fibers, infusible chemical fibers, and fibers with a melting point being higher than that of said thermoplastic matrix material.
